(19) United States
(12) Patent Application Publication
(10) Pub. No.: US 2020/0305392 A1
(43) Pub. Date: Oct. 1, 2020

(54) PET TOY WITH TREAT

(71) Applicant: Royal Pet Incorporated, South St. Paul, MN (US)

(72) Inventor: Troy Petersen, Rosemount, MN (US)

(21) Appl. No.: 16/370,251

(22) Filed: Mar. 29, 2019

(51) Int. Cl. A01K 15/02

(52) U.S. Cl. CPC A01K 15/025

(57) ABSTRACT

A pet toy includes a first portion comprising a non-linear configuration having a front end to a tail end, wherein the first portion is configured to slidably retain a treat. The pet toy includes a second portion attached to the front end of the first portion, the second configured to provide weight to the pet toy.

### BACKGROUND

The present disclosure relates to a pet toy. More particularly, the present disclosure relates to a pet toy that accepts at treat that a pet will interact with to attempt to remove from the toy.

There are a variety of toys for pets with various designs and purposes. Pet toys for domestic pets, such as cats, may be designed for play and encourage interaction.

However, pets can become disinterested in a toy in a short amount of time. To retain the pet's interest, some pet toys can include attractants, such as scents, noise makers, different textures and/or different materials of construction.

### SUMMARY

This Summary and Abstract are provided herein to introduce a selection of concepts in simplified form that are further described below in the Detailed Description. The Summary and Abstract are not intended to identify key features or essential features of the claimed subject matter, nor are they intended to be used as an aid in determining the scope of the claimed subject matter. The claimed subject matter is not limited to the implementations that solve any or all the disadvantages noted in the background.

An aspect of the present disclosure relates a pet toy. The pet toy includes a first portion comprising a non-linear configuration having a front end to a tail end, wherein the first portion is configured to slidably retain a treat. The pet toy includes a second portion attached to the front end of the first portion, the second configured to provide weight to the pet toy.

Another aspect of the present disclosure relates a pet toy. The pet toy includes a first portion comprising a non-linear configuration having a front end to a tail end, wherein the first portion is configured to slidably retain a treat. The pet toy includes a second portion attached to the front end of the first portion, the second configured to provide weight to the pet toy. The pet toy includes one or more treats having a through bore, wherein the through bore has a diameter sized to allow the one or more treats to be slidably positioned on the first portion.

Another aspect of the present disclosure relates to a method of entertaining a pet with a toy. The method includes providing a body with a first portion having a non-linear configuration and a weighted second portion coupled to a front end of the first portion, and providing a treat with a through bore having a diameter sized to allow the one or more treats to be slidably positioned on the first portion. The method includes slidably positioning the treat on the first portion, and providing the toy with the treat to the pet.

### BRIEF DESCRIPTION OF THE DRAWINGS

FIG. 1 is a perspective front view of a pet toy of the present disclosure.

FIG. 2 is a side view of an embodiment of the present disclosure.

FIG. 3 is a top view of an embodiment of the present disclosure.

FIG. 4A is a perspective view of treats that may be used with a pet toy according to an embodiment of the present disclosure.

FIG. 4B is a perspective view of a pet toy with a treat according to an embodiment of the present disclosure.

FIG. 5 is a method of entertaining a pet with a pet toy according to an embodiment of the present disclosure.

### DETAILED DESCRIPTION

Although the present disclosure has been described with reference to preferred embodiments, workers skilled in the art will recognize that changes may be made in form and detail without departing from the scope of the disclosure. The present disclosure generally pertains to a toy for an animal.

The present disclosure relates to a combination of a pet toy and at least one pet treat that can be slidably attached to the pet toy. The pet toy and at least one pet treat can be provided as a kit in a single package, provided in separate packages and additional packages of treats can be provided as the treats are consumed.

The pet toy includes a non-linear portion about which a treat is positioned such that the pet is required to manipulate the treat about the non-linear portion. What is meant by non-linear is a shape that is substantially arcuate or curved or includes arcuate or curved portions with substantially straight portions between the arcuate or curved portions. Because the portion is non-linear, the pet is required to spend significantly more time with the toy to separate the treat from the toy, which results in greater interaction and activity.

The pet toy is typically utilized by a cat. However, the pet toy is not limited to use by cats, as the pet toy can be utilized by any species of pet.

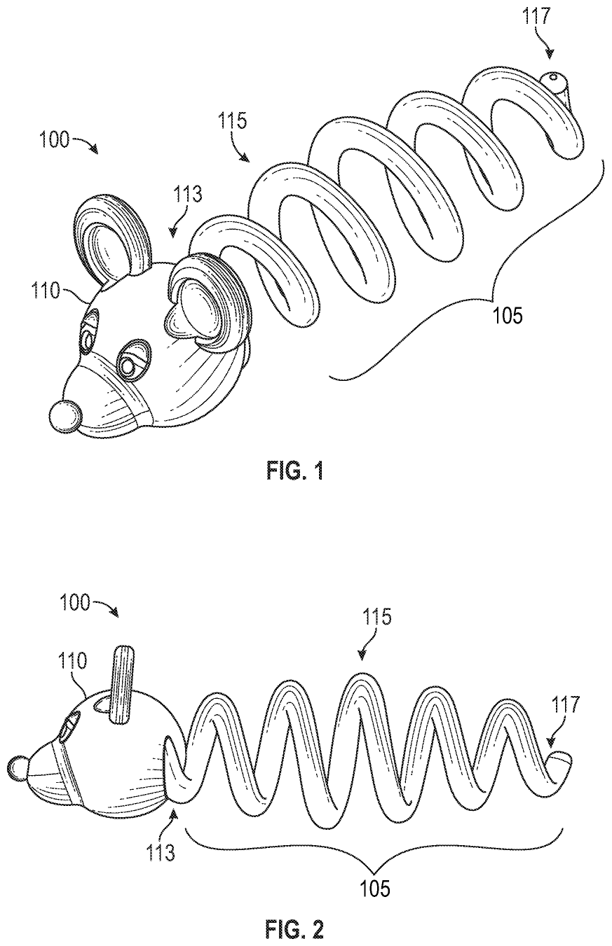

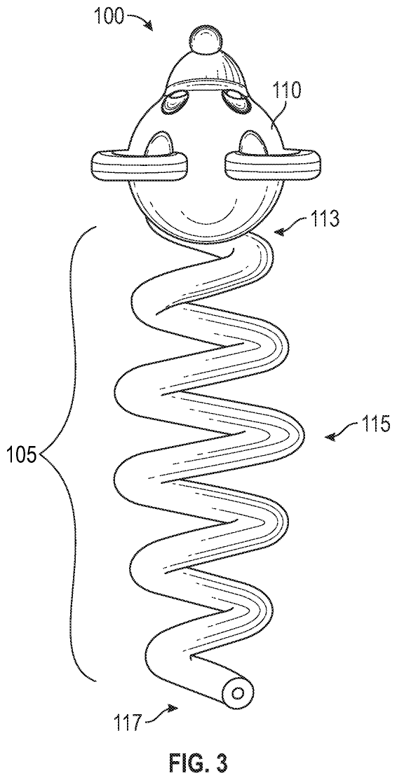

A pet toy 100 is generally illustrated in FIGS. 1-3. The pet toy 100 including a first, non-linear portion 105 attached to a second portion 110 that provides a weighted end. The first, non-linear portion 105 includes a helical shaped coil which may be configured to retain an attractant, such as a treat. The coil 105 has a first end 113 that is attached to the second portion 110 and a free tail end 117. The coil 105 has in increasing diameter from the first end 113 to an apex 115 and a decreasing diameter from the apex 155 to the free tail end 117.

While a helical shaped coil 105 is illustrated, the present disclosure is not limited to a helical shaped coil. Rather, the present disclosure includes any non-linear portion 105, including but not limited to, a wave form and/or a shape having one or more curved portions and one or more straight portions.

The body also includes a second portion 110 attached to the front end 113 of the helical coil 105. The second portion 110 is solid and provides weight to the toy 100. As illustrated, the second portion 110 resembles a head of an animated mouse. However, the second portion 110 can be any figural or geometric shape.

The pet toy 100 is typically of a unitary construction where the first portion 105 and the second portion 110 are molded from a polymeric material. Alternatively, the first portion 105 and the second portion 110 can be constructed from different materials and secured together. The pet toy 100 can be formed from any material that is generally safe for pets, such as a cat. The material of construction can be rigid or flexible, depending upon the desired physical properties.

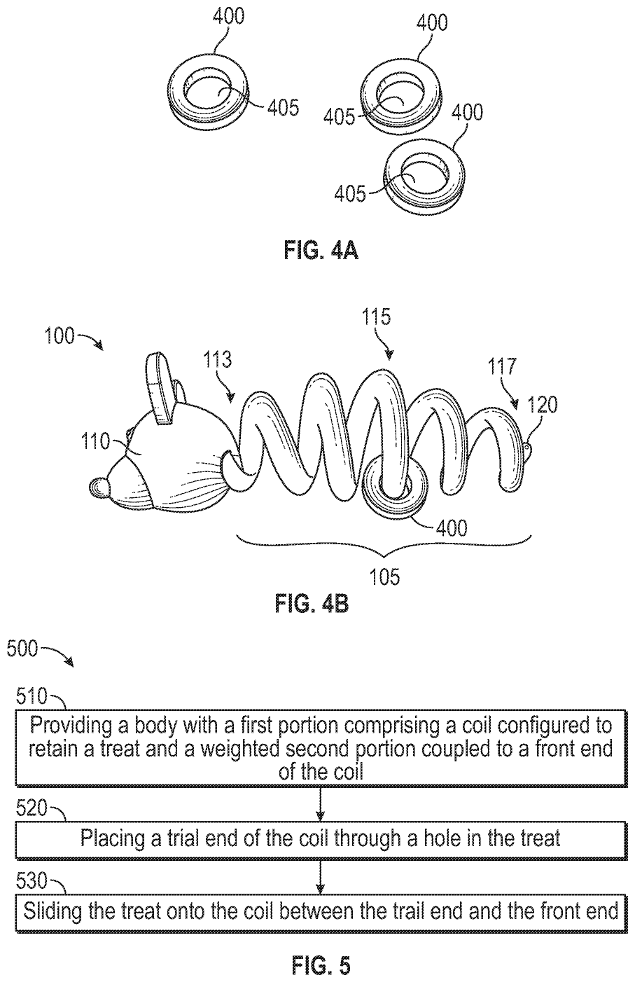

An edible treat for use with the pet toy 100 is illustrated in FIGS. 4A and 4B at 400. The treats 400 are ring shaped with a through bore 405 having diameter that is configured to be slidably positioned about the helical coil 105. Treat 400 may include an attractant to entice a pet to play with pet toy 100 and reward the pet with the treat. While the treat 405 is illustrated as being ring shaped, the treat 405 can be any shape provided the treat includes a through bore 405, treat 400 may have variety of shapes and sizes provided the treat 400 has a through bore 405 with a diameter or width that allows the treat 400 to be slidably positioned about the non-linear second portion 110.

Treat 400 may slide freely along the helical coil 105 and therefore be manipulated by the pet. As illustrated, a single treat 400 is placed on the coil 105. However, one or more treats 400 can be positioned on the coil at one or more locations for the pet to engage.

FIG. 5 is a flowchart of a method 500 of entertaining a pet with a toy. Method 500 includes providing 510 a body with a first portion comprising a coil configured to retain a treat and a weighted second portion attached to a front end of the coil. The method 500 also includes placing 520 a tail end of the coil through a hole in the treat. The method 500 further includes sliding 530 the treat onto the coil between the tail end and the front end.

The illustrations of the embodiments described herein are intended to provide a general understanding of the various embodiments. The illustrations are not intended to serve as a complete description of all of the elements and features of methods and apparatus described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure is not to be interpreted as reflecting an intention that the claimed embodiments employ more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A pet toy comprising:
a first portion comprising a non-linear configuration having a front end to a tail end, wherein the first portion is configured to slidably retain a treat; and
a second portion attached to the front end of the first portion, the second configured to provide weight to the pet toy.

2. The pet toy of claim 1, wherein the first portion comprises a helical coil.

3. The pet toy of claim 2, wherein the coil increases in diameter from the front end to a location between the front end and the tail end and decreases in diameter from the location to the tail end.

4. The pet toy of claim 3, wherein the location between the front end and the tail end comprises a midpoint of a length of the helical coil.

5. The pet toy of claim 1, wherein the first portion and the second portion are of a unitary construction.

6. The pet toy of claim 1, where the first portion and the second portion are molded as a unitary construction.

7. The pet toy of claim 1, wherein the first portion and the second portion are constructed of a polymeric material.

8. The pet toy of claim 1, wherein the first portion and the second portion are constructed of an elastomeric material.

9. The pet toy of claim 1, wherein the second portion resembles the head of an animal.

10. A pet toy comprising:
a first portion comprising a non-linear configuration having a front end to a tail end, wherein the first portion is configured to slidably retain a treat;
a second portion attached to the front end of the first portion, the second configured to provide weight to the pet toy; and
one or more treats having a through bore, wherein the through bore has a diameter sized to allow the one or more treats to be slidably positioned on the first portion.

11. The pet toy of claim 10, wherein the first portion comprises a helical coil.

12. The pet toy of claim 11, wherein the coil increases in diameter from the front end to a location between the front end and the tail end and decreases in diameter from the location to the tail end.

13. The pet toy of claim 12, wherein the location between the front end and the tail end comprises a midpoint of a length of the helical coil.

14. The pet toy of claim 10, wherein the first portion and the second portion are of a unitary construction.

15. The pet toy of claim 10, where the first portion and the second portion are molded as a unitary construction.

16. The pet toy of claim 10, wherein the first portion and the second portion are constructed of a polymeric material.

17. A method of entertaining a pet with a toy comprising:
providing a body with a first portion having a non-linear configuration and a weighted second portion coupled to a front end of the first portion;
providing a treat with a through bore having a diameter sized to allow the one or more treats to be slidably positioned on the first portion;
slidably positioning the treat on the first portion; and
providing the toy with the treat to the pet.

18. The method of claim 17, wherein the first portion comprises a helical coil.

19. The method of claim, wherein the treat has a ring shaped configuration.
